(19) United States
(12) Patent Application Publication
(10) Pub. No.: US 2013/0191125 A1
(43) Pub. Date: Jul. 25, 2013

(54) TRANSCRIPTION SUPPORTING SYSTEM AND TRANSCRIPTION SUPPORTING METHOD

(71) Applicant: Kabushiki Kaisha Toshiba, Tokyo (JP)

(72) Inventors: Hirokazu SUZUKI, Tokyo (JP); Nobuhiro Shimogori, Kanagawa (JP); Tomoo Ikeda, Tokyo (JP); Taira Ashikawa, Kanagawa (JP); Manabu Nagao, Kanagawa (JP); Osamu Nishiyama, Kanagawa (JP); Masayuki Ashikawa, Kanagawa (JP)

(73) Assignee: Kabushiki Kaisha Toshiba, Tokyo (JP)

(21) Appl. No.: 13/747,939

(22) Filed: Jan. 23, 2013

(30) Foreign Application Priority Data
Jan. 25, 2012 (JP) 2012-013355

(51) Int. Cl. G10L 15/26

(52) U.S. Cl. CPC G10L 15/26
USPC 704/235

(57) ABSTRACT

A transcription supporting system for the conversion of voice data to text data includes a first storage module, a playing module, a voice recognition module, an index generating module, a second storage module, a text forming module, and an estimation module. The first storage module stores the voice data. The playing module plays the voice data. The voice recognition module executes the voice recognition processing on the voice data. The index generating module generates a voice index that makes the plural text strings generated in the voice recognition processing correspond to voice position data. The second storage module stores the voice index. The text forming module forms text corresponding to input of a user correcting or editing the generated text strings. The estimation module estimates the formed voice position indicating the last position in the voice data where the user corrected/confirmed the voice recognition.

### CROSS-REFERENCE TO RELATED APPLICATION

This application is based upon and claims the benefit of priority from Japanese Patent Application No. 2012-013355, filed Jan. 25, 2012; the entire contents of which are incorporated herein by reference.

### FIELD

Embodiments described herein relate generally to a transcription supporting system and a transcription supporting method for supporting a transcription operation that converts voice data to text.

### BACKGROUND

In the related art, there are various technologies for increasing the efficiency of the transcription operation by a user. For example, according to one technology, plural text strings obtained by executing a voice recognition processing on recorded voice data form voice text data and the time code positions of the voice data (playing positions) are made to correspond to each other while represented on a screen. According to this technology, when a text string on the screen is selected, the voice data are played from a playing position corresponding to the text string, so that a user (a transcription operator) may select a text string and carry out correction of the text string while listening to the voice data.

Furthermore, according to this technology, it is necessary to have the plural text strings that form the voice text data correspond to the playing positions of the voice data while displaying the plural text strings on a screen. Consequently, the display control system becomes complicated, and this is undesirable.

In addition, the transcription operation is seldom carried out with voice data containing filler and grammatical errors as it is, and a text correcting operation is usually carried out by the user. That is, there is a significant difference between the voice data and the text which is taken as the transcription object by the user. Consequently, when the technology is adopted, and an operation is carried out to correct the voice recognition results of the voice data, the efficiency of the operation is not high. As a result, instead of the transcription system carrying out the operation for correcting the voice recognition results, it is preferred to convert a listening range, which is a small segment of the voice data the user could listen, to text while playing the voice data. In this process it is necessary for the user to repeatedly pause and rewind the voice data while performing the transcription operation. When pause is turned off and playing of the voice data is restarted (when transcription is restarted), it is preferred that the playing be automatically restarted from the position where the transcription last ended within the voice data.

However, the related art is problematic in that it is difficult to specify or determine the position where transcription ended within the voice data.

### DESCRIPTION OF THE DRAWINGS

FIG. 1 is a block diagram illustrating schematically an example of a transcription supporting system according to a first embodiment.

FIG. 2 is a diagram illustrating an example of voice text data.

FIG. 3 is a diagram illustrating an example of a voice index.

FIG. 4 is a flow chart illustrating an example of a text forming processing.

FIG. 5 is a flow chart illustrating an example of an estimation processing.

FIG. 6 is a block diagram illustrating schematically an example transcription supporting system according to a second embodiment.

FIG. 7 is a flow chart illustrating an example of a processing for correcting the voice index.

FIG. 8 is a diagram illustrating a second example of voice text data.

FIG. 9 is a diagram illustrating a second example of a voice index.

FIG. 10 is a diagram illustrating a third example of a voice index.

FIG. 11 is a diagram illustrating a fourth example of a voice index.

FIG. 12 is a diagram illustrating a third example of voice text data.

FIG. 13 is a diagram illustrating a fourth example of voice text data.

### DETAILED DESCRIPTION

The present disclosure describes a transcription (voice-to-text conversion) supporting system and a transcription supporting method that allows specification of the position where transcription ended within the voice data.

In general, embodiments of the transcription supporting system will be explained in more detail with reference to annexed figures. In the following embodiments, as the transcription supporting system, a PC (personal computer) having the function of playing of voice data and a function of text formation for forming text corresponding to an operation of a user will be taken as an example for explanation. However, the present disclosure is not limited to this example.

The transcription supporting system according to one embodiment has a first storage module, a playing module, a voice recognition module, an index generating module, a second storage module, a text forming module, and an estimation module. The first storage module stores the voice data. The playing module plays the voice data. The voice recognition module executes voice recognition processing on the voice data. The index generating module generates a voice index that correlates plural text strings generated during the voice recognition processing with corresponding voice position data indicating positions (e.g., a time position or time coordinate) in the voice data. The second storage module stores the voice index. The text forming module corrects the text generated by the voice recognition processing according to a text input by a user. The user may listen to the voice data during the text correction process. The estimation module estimates the position in the voice data where the user made a correction (a correction may include a word change, deletion of filler, inclusion of punctuation, confirmation of the voice recognition result, or the like). The estimation of the position in the voice data where the correction was made may be made on the basis of information in the voice index.

In the embodiments presented below, when the transcription operation is carried out, the user replays recorded voice data while manipulating a keyboard to input text for editing and correcting converted voice text data. In this case, the transcription supporting system estimates the position of the voice data where the transcription ended (i.e., the position where the user left off editing/correcting the converted voice text data). Then, upon the instruction of the user, the voice data are played from the estimated position. As a result, even when playing of the voice data is paused during the conversion process, the user can restart playing of the voice data from the position where transcription ended.

### First Embodiment

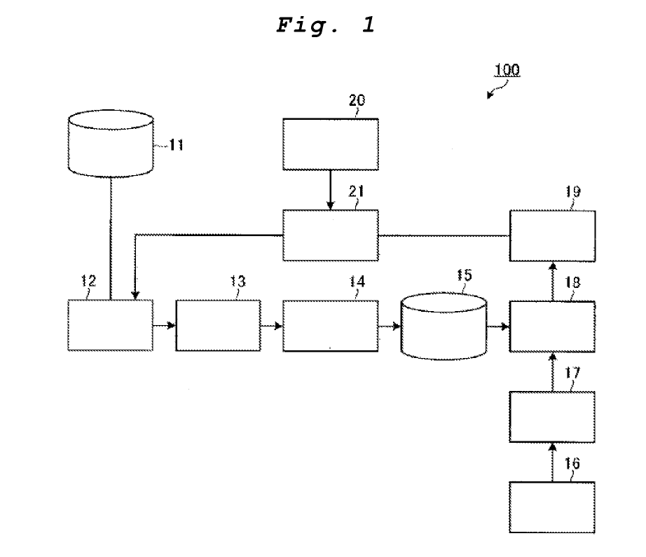

FIG. 1 is a block diagram illustrating schematically an example of the components of a transcription supporting system 100 related to a first embodiment. As shown in FIG. 1, the transcription supporting system 100 has a first storage module 11, a playing module 12, a voice recognition module 13, an index generating module 14, a second storage module 15, an input receiving module 16, a text forming module 17, an estimation module 18, a setting module 19, a playing instruction receiving module 20, and a playing controller 21.

The first storage module 11 stores the voice data. The voice data are in a sound file in a wav, mp3, or the like format. There is no specific restriction on the method for acquiring the voice data. For example, voice data may be acquired via the Internet or other network, or by a microphone or the like. The playing module 12 plays the voice data, and it may include a speaker, a D/A (digital/analog) converter, a headphone, or related components.

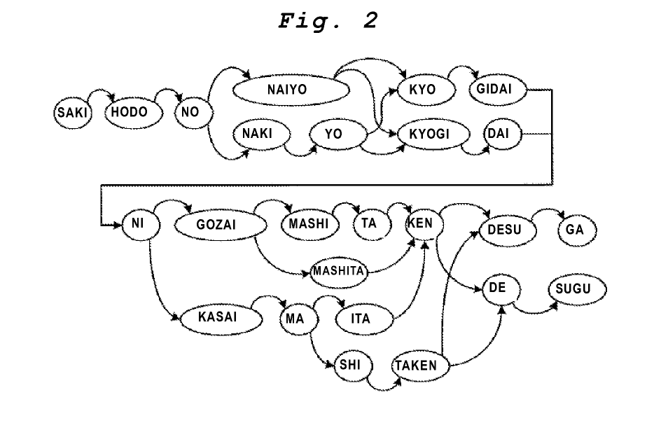

The voice recognition module 13 carries out a voice recognition processing on the voice data to convert the voice data to text data. The text data obtained in the voice recognition processing are called “voice text data.” The voice recognition processing may be carried out using various well known technologies. In the present embodiment, the voice text data generated by the voice recognition module 13 are represented by a network structure known as lattices (as depicted in FIG. 2, for example) where the voice text data are divided into words, morphemes, clauses, and other units smaller than a sentence, and the recognition candidates (candidates for the dividing units) are connected.

However, the form of the voice text data is not limited to this type of representation. For example, the voice text data may also be represented by a one-dimensional structure (one path) that represents the optimum/best recognition result from the voice recognition processing. FIG. 2 is a diagram illustrating an example of the voice text data obtained by carrying out the voice recognition processing for the voice data of “the contents are the topic for today” (in Japanese (romaji): “saki hodo no naiyo, kyo gitai ni gozaimashita ken desu ga”). In the example shown in FIG. 2, the dividing units are morphemes.

The voice recognition module 13 includes a recognition dictionary related to the recognizable words. When a word not registered in the recognition dictionary is contained in the voice data, the voice recognition module 13 takes this unregistered word as an erroneous recognition. Consequently, in order to improve the recognition accuracy, it is important to customize the recognition dictionary to correspond to the words likely to be contained in the voice data.

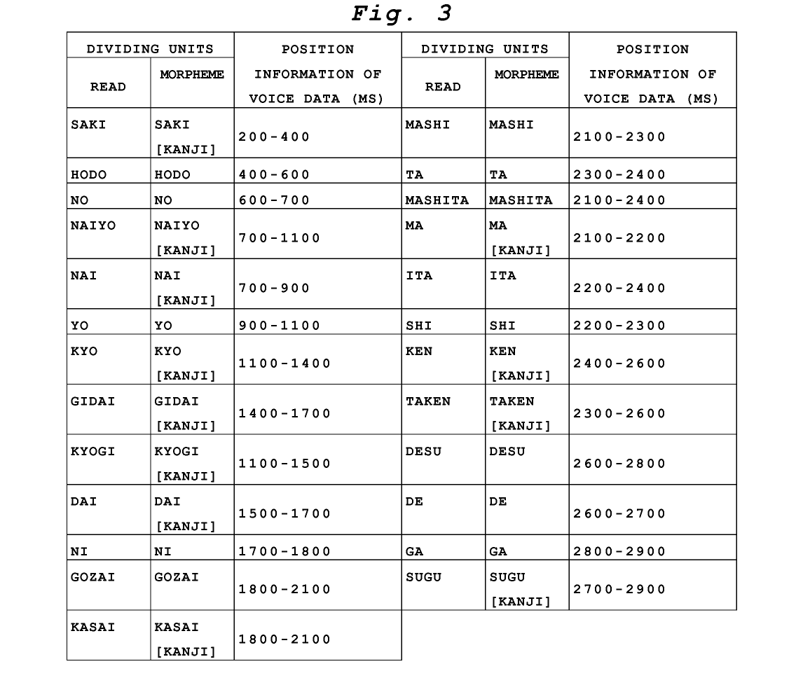

The index generating module 14 generates a voice index with plural text strings formed from the voice text data generated by the voice recognition module 13 with each of the text strings corresponding to voice position information indicating a respective position in the voice data (playing position). For example, for the voice text data shown in FIG. 2 module, the index generating module 14 has the morphemes that form the voice text data related to voice position information. As a result, a voice index, such as shown in FIG. 3, is generated.

In voice recognition processing, the voice data are typically processed at a prescribed interval of about 10 to 20 ms. Correspondence between the voice data and the voice position information can be obtained during voice recognition processing by matching the recognition results with corresponding time position in the voice data.

In the example shown in FIG. 3, the voice position information of the voice data is represented by time information indicating time needed for playing from the head (the recording starting point) of the voice data to the position (in units of milliseconds (ms)). For example, as shown in FIG. 3, the voice position information corresponding to “kyo” (in English: “today”) is “1100 ms-1400 ms.” This means that when the voice data are played, for the sound of “kyo,” the playing start position is 1100 ms, and the playing end portion is 1400 ms. In other words, when voice data are played, the period from a start point of 1100 ms from the head of the voice data until an end point of 1400 ms from the head of the voice data is a period of playing of the sound corresponding to “kyo.”

Referring back to FIG. 1, the second storage module 15 stores the voice index generated by the index generating module 14. However, one may also adopt a scheme in which the voice index is prepared before the start of the transcription operation, or it may be formed in real time during the transcription operation.

The input receiving module 16 receives the various types of inputs (called “text inputs”) from the user for forming the text. While listening to the played voice data from the playing module 12, the user inputs the text representing the voice data contents. Text inputs can be made by manipulating a user input device, such as a keyboard, touchpad, touch screen, mouse pointer, or similar device. The text forming module 17 forms a text corresponding to the input from the user. More specifically, the text forming module 17 forms text corresponding to the text input received by the input receiving module 16. In the following, in order to facilitate explanation, the text formed by the text forming module 17 may be referred to as “inputted text.”

FIG. 4 is a flow chart illustrating an example of a text formation processing carried out by the text forming module 17. As shown in FIG. 4, when a text input is received by the input receiving module 16 (YES as the result of step S1), the text forming module 17 judges whether the received text input is an input instructing line feed or an input of punctuation marks (“punctuation”) (step S2). Here, examples of punctuation marks include periods, question marks, exclamation marks, commas, etc.

When it is judged that the text input received in step S1 is an input instructing line feed or input of punctuation (YES as the result of step S2), the text forming module 17 confirms that the text strings from a head input position to a current input position are the text (step S3). On the other hand, when it is judged that the text input received in step S1 is not an input instructing line feed or an input of punctuation (NO as the result of step S2), the processing goes to step S4.

In step S4, the text forming module 17 judges whether the received text input is an input confirming the conversion processing. An example of the conversion processing is the processing for converting Japanese kana characters to Kanji characters. Here, the inputs instructing confirmation of the conversion processing also include an input instructing confirmation of keeping the Japanese characters as is without converting them to Kanji characters. When it is judged that the received text input is an input instructing confirmation of the conversion processing (YES as the result of step S4), the processing goes to the step S3 and the text strings, up to the current input position, are confirmed to be the text. Then the text forming module 17 sends the confirmed text (the inputted text) to the estimation module 18 (step S5). Here the text forming processing comes to an end.

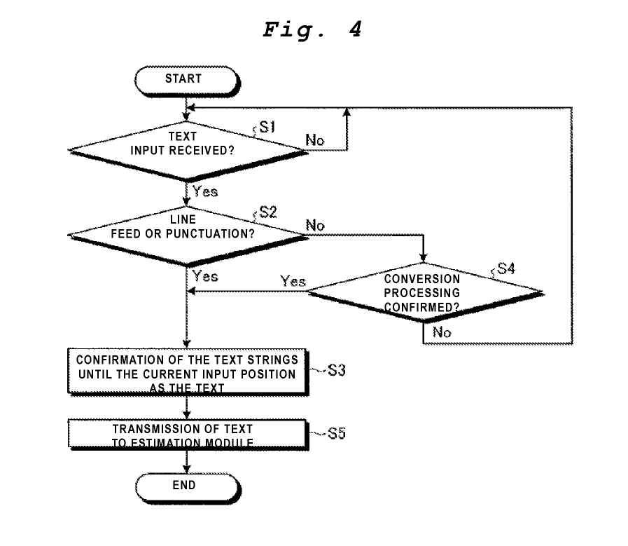

Referring back again to FIG. 1, the estimation module 18 estimates, on the basis of the voice index, the formed voice position information indicating the position where formation of text ends (the position where transcription ends). FIG. 5 is a flow chart illustrating an example of the estimation processing carried out by the estimation module 18. As shown in FIG. 5, when the inputted text is acquired (YES as the result of step S10), the estimation module 18 judges whether there exists a text string contained in the voice index that is in agreement with the text strings that form the inputted text (text strings with morphemes as units) (step S11). Checking whether there exists a text string in agreement that can be accomplished by matching the text strings.

In step S11, when it is judged there exists in the inputted text a text string in agreement with a text string contained in the voice index (YES as the result of step S11), the estimation module 18 judges whether the text string at the end of the inputted text (the end text string) is in agreement with the text string contained in the voice index (step S12).

In the step S12, when it is judged that the end text string is in agreement with the text string contained in the voice index (YES as the result of step S12), the estimation module 18 reads, from the voice index, the voice position information corresponding to the end text string and estimates the formed voice position information from the read out voice position information (step S13). If in the step S12 it is judged that the end text string is not in agreement with any text string contained in the voice index (NO as the result of step S12), then the processing goes to step S14.

In step S14, the estimation module 18 reads the voice position information for a reference text string corresponding to the text string nearest the end text string, the reference text string selected from among the text strings in agreement with the text strings contained in the voice index. Also, the estimation module 18 estimates a first playing time (step S15). The first playing time is a time needed for playing of the text strings not in agreement with the text strings in the voice index. The first playing time corresponds to a time period from the first text string after the reference text string to the end text string. There is no specific restriction on the method for estimating the first playing time. For example, one may also adopt a scheme in which the text string is converted to a phoneme string, and, by comparing each phoneme to reference data for phoneme continuation time, the time needed for playing (speaking) of the text string can be estimated.

From the voice position information readout in step S14 (the voice position information corresponding to the reference text string) and the first playing time estimated in step S15, the formed voice position information is estimated by estimation module 18 (step S16). More specifically, estimation module 18 may estimate the position ahead of the end of the reference text string by adding the first playing time (estimated in step S15). The time until the end of the reference text plus the first playing time is taken as the formed voice position information.

On the other hand, in the step S11, when it is judged that there exists no text string in the inputted text which is in agreement with the text string contained in the voice index (NO as the result of step S11), the estimation module 18 estimates the time needed for playing of the inputted text as a second playing time (step S17). There is no specific restriction on the method of estimation of the second playing time. For example, one may adopt the method in which the text strings of the inputted text are converted to phoneme strings, and, by using reference data for phoneme continuation times with respect to each phoneme, the time needed for playing (speaking) of the text strings can be estimated. Then, the estimation module 18 estimates the voice position information formed from the second playing time (step S18).

The following is a specific example of a possible embodiment. Suppose the user (the operator of the transcription operation) listens to the voice data “saki hodo no naiyo, kyo kitai ni gozaimashita ken desu ga” (in English: “the contents are the topic for today”), and the user then carries out the transcription operation. Here, playing of the voice data is paused at the end position of the voice data. In this example, it is assumed that before the start of the transcription operation the voice index shown in FIG. 3 has been generated, and this voice index is stored in the second storage module 15.

At first, the user inputs the text string of “saki hodo no” and confirms that the input text string is to be converted to Kanji, so that the inputted text of “saki hodo no” is transmitted to the estimation module 18. First, the estimation module 18 judges whether there exists a text string among the text strings forming “saki hodo no” (“saki”, “hodo”, “no”) that is in agreement with the text strings contained in the voice index (step S11 shown in FIG. 5). In this case, because all of the text strings that form the “saki hodo no” are in agreement with text strings contained in the voice index, the estimation module 18 reads the voice position information corresponding to the end text string of “no” from the voice index and estimates the voice position information formed from the read out voice position information (step S12 and step S13 in FIG. 5). In this example, the estimation module 18 estimates the end point of 700 ms of the voice position information of “600 ms-700 ms” corresponding to the end text string “no” as the formed voice position information.

Then, the user inputs the text string of “gidai ni” after the text string of “saki hodo no” and confirms conversion of the inputted text string to Kanji. As a result, the inputted text of “saki hodo no gidai ni” is transmitted to the estimation module 18. First, the estimation module 18 judges whether there exist text strings among the text strings that form the “saki hodo no gidai ni” (“saki”, “hodo”, “no”, “gidai”, “ni”) in agreement with the text strings contained in the voice index (step S11 shown in FIG. 5). In this case, all of the text strings that form “saki hodo no gidai ni” are in agreement with the text strings contained in the voice index, so that the estimation module 18 reads the voice position information corresponding to the end text string “ni” from the voice index and estimates the formed voice position information from the read out voice position information (steps S12 and S13 in FIG. 5). In this example, the estimation module 18 estimates that the voice position information of “1700 ms-1800 ms” corresponding to the end text string “ni” as the formed voice position information.

Then, the user inputs the text string of “nobotta” after the “saki hodo no gidai ni” and confirms the input text string (that is, confirming “nobotta” is to be kept as it is in Japanese characters and not converted to Kanji characters), so that the inputted text of “saki hodo no gidai ni nobotta” is transmitted to the estimation module 18. First, the estimation module 18 judges whether there exist text strings among the text strings that form the “saki hodo no gidai ni nobotta” (“saki”, “hodo”, “no”, “gidai”, “ni”, “nobotta”) in agreement with the text strings contained in the voice index (step S11 shown in FIG. 5). In this case, among the 5 text strings that form the “saki hodo no gidai ni nobotta,” 4 text strings (“saki”, “hodo”, “no”, “gidai”, “ni”) are in agreement with the text strings contained in the voice index, yet the end text string of “nobotta” is not in agreement with the text strings contained in the voice index. That is, the end text string of “nobotta” does not exist in the voice index (NO as the result of step S12).

Consequently, the estimation module 18 reads out from the voice index the voice position information of “1700 ms-1800 ms” corresponding to the reference text string of “ni” indicating the text string nearest the end text string (“nobotta”) from among the text strings in agreement with the text strings contained in the voice index (step S14 shown in FIG. 5). The estimation module 18 then estimates the first playing time needed for playing of the text string not in agreement with the text strings in the voice index by first selecting, as a reference text string, the text string nearest to the end text which does correspond to a text string in the voice index. Here, the reference text string is the text string corresponding to “ni.” The first playing time is then estimated by using the end point of the reference text string to the end text string among the text strings that form the inputted text (“saki”, “hodo”, “no”, “gidai”, “ni”, “nobotta”) (step S15 shown in FIG. 5). According to this example, the text string is “nobotta” is not in agreement with a text string in the voice index and the result of estimation of the time needed for playing of the “nobotta” is 350 ms. In this case, the estimation module 18 estimates the position of “2150 ms” (calculated by adding the 350 ms needed for playing of “nobotta” to the end point (1800 ms) of the voice position information of “1700 ms-1800 ms” corresponding to the reference text string of “ni”) as the formed voice position information (step S16 shown in FIG. 5).

Then, the user inputs the text string of “ken desu ga” after the “saki hodo no gidai ni nobotta” and confirms conversion of the input text string to Kanji, so that the inputted text of “saki hodo no gidai ni nobotta ken desu ga” is transmitted to the estimation module 18. First, the estimation module 18 judges whether there exist text strings among the text strings that form the “saki hodo no gidai ni nobotta ken desu ga” (“saki”, “hodo”, “no”, “gidai”, “ni”, “nobotta”, “ken”, “desu”, “ga”) in agreement with the text strings contained in the voice index (step S11 shown in FIG. 5). In this case, of the nine text strings that form “saki hodo no gidai ni nobotta ken desu ga,” eight text strings (“saki”, “hodo”, “no”, “gidai”, “ni”, “ken”, “desu”, “ga”) are in agreement with the text strings contained in the voice index. The end text string of “ga” is also in agreement with the text strings contained in the voice index. Consequently, the estimation module 18 reads out from the voice index the voice position information corresponding to the end text string of “ga” and estimates the formed voice position information from the read out voice position information (step S12, step S13 shown in FIG. 5). The estimation module 18 estimates the voice position information of “2800 ms-2900 ms” corresponding to the end text string of “ga” as the formed voice position information.

In this example, among the text strings that form the inputted text, the text string of “nobotta” which is not contained in the voice index is ignored and agreement of the end text string with the text string contained in the voice index is taken as the preference for estimating the formed voice position information from the voice position information corresponding to the end text string. That is, when the end text string among the text strings that form the text is in agreement with the text string contained in the voice index, the formed voice position information is estimated unconditionally (without concern for unrecognized text strings) from the voice position information corresponding to the end text string. However, the present disclosure is not limited to the scheme. For example, one may also adopt the following scheme: even when the end text string is in agreement with the text string contained in the voice index, if a prescribed condition is not met, the formed voice position information is not estimated from the voice position information corresponding to the end text string.

The prescribed condition may be set arbitrarily. For example, when the number of the text strings among the inputted text that are in agreement with the text strings contained in the voice index is over some prescribed number (or percentage), the estimation module 18 could judge that the prescribed condition is met. Or the estimation module 18 could judge whether the prescribed condition is met if among the text strings other than the end text string of the inputted text and, there exist text strings in agreement with the text strings contained in the voice index and the difference between the position indicated by the voice position information corresponding to a recognized reference text string nearest the end text string and the position indicated by the voice position information corresponding to the end text string is within some prescribed time range.

Referring back again to FIG. 1, on the basis of the formed voice position information estimated by the estimation module 18, the setting module 19 sets the playing start position indicating the position of the start of playing among the voice data. In the present example, the setting module 19 set the position indicating the formed voice position information estimated by the estimation module 18 as the playing start position.

The playing instruction receiving module 20 receives a playing instruction that instructs the playing (playback) of the voice data. For example, the user may use a mouse or other pointing device to select a playing button displayed on the screen of a computer so as to input the playing instruction. However, the present disclosure is not limited to this scheme. There is no specific restriction on the input method for the playing instruction. In addition, according to the present example, the user may manipulate the mouse or other pointing device to select a stop button, a rewind button, a fast-forward button, or other controls displayed on the screen of the computer so as to input various types of instructions and the playing of the voice data is controlled corresponding to the user input instructions.

When a playing instruction is received by the playing instruction receiving module 20, the playing controller 21 controls the playing module 12 so that the voice data are played from the playing start position set by the setting module 19. The playing controller 21 can be realized, for example, by the audio function of the operation system and driver of the PC. It may also be realized by an electronic circuit or other hardware device.

According to the present example, the first storage module 11, the playing module 12 and the second storage module 15 are made of hardware circuits. On the other hand, the voice recognition module 13, index generating module 14, input receiving module 16, text forming module 17, estimation module 18, setting module 19, playing instruction receiving module 20 and playing controller 21 each are realized by a PC CPU executing a control program stored in ROM (or other memory or storage system). However, the present disclosure is not limited to this scheme. For example, at least a portion of the voice recognition module 13, index generating module 14, input receiving module 16, text forming module 17, estimation module 18, setting module 19, playing instruction receiving module 20 and playing controller 21 may be made of hardware devices or electronic circuits.

As explained above, according to the present example, the transcription supporting system 100 estimates the formed voice position information indicating the position of the end of formation of the text (that is, the end position of transcription) among the voice data on the basis of the voice index that has the plural text strings forming the voice text data obtained by executing the voice recognition processing for the voice data and the voice position information of the voice data corresponding with each other. As a result, the user carries out the transcription operation while correcting the errors in filler and grammar contained in the voice data, and, even when the inputted text and the voice text data (voice recognition results) are different from each other, it is still possible to correctly specify the position of the end of the transcription among the voice data.

According to the present example, the transcription supporting system 100 sets the position of the voice data indicating the estimated formed voice position information as the playing start position. Consequently, there is no need for the user to match the playing start position to the position of the end of the transcription while repeatedly carrying out rewinding and fast-forward operations on the voice tape (voice data). As a result, it is possible to increase the user operation efficiency.

### Second Embodiment

For the transcription supporting system related to a second example embodiment, in addition to the functions described above for the first embodiment, it also decreases the influence of erroneous recognitions contained in the voice text generated by the voice recognition module 13.

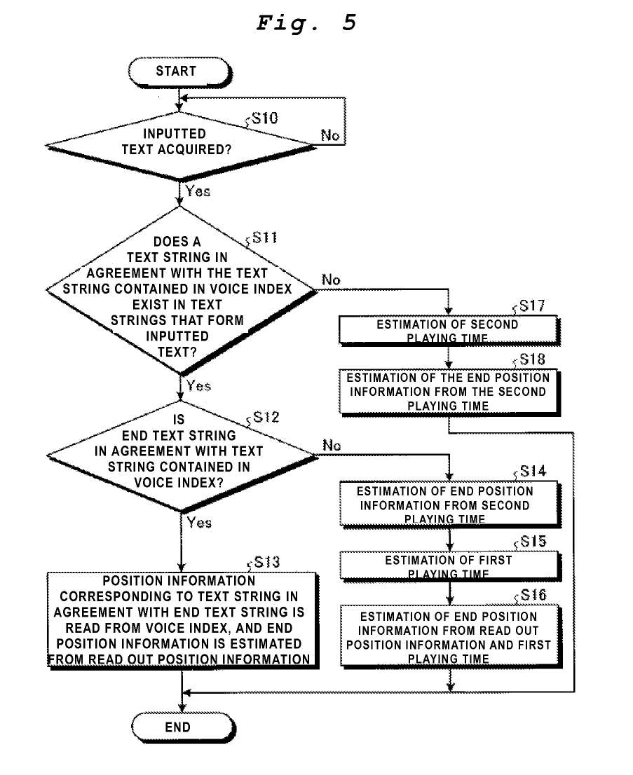

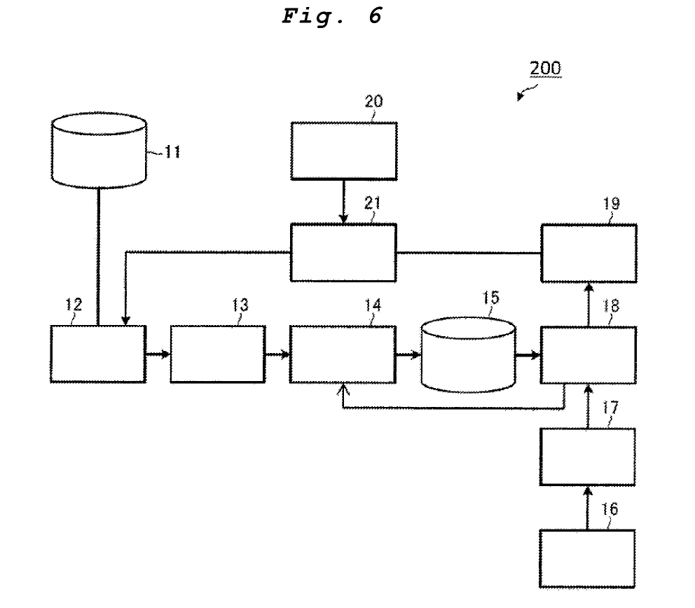

FIG. 6 is a block diagram illustrating schematically a transcription supporting system 200 related to the second embodiment. It differs from the transcription supporting system 100 related to the first embodiment in that the index generating module 14 corrects the voice index on the basis of the estimation processing of the voice position information in the estimation module 18. More specifically, when a text string of the inputted text is not in agreement with the text strings contained in the voice index stored in the second storage module 15, this text string is added to the voice index.

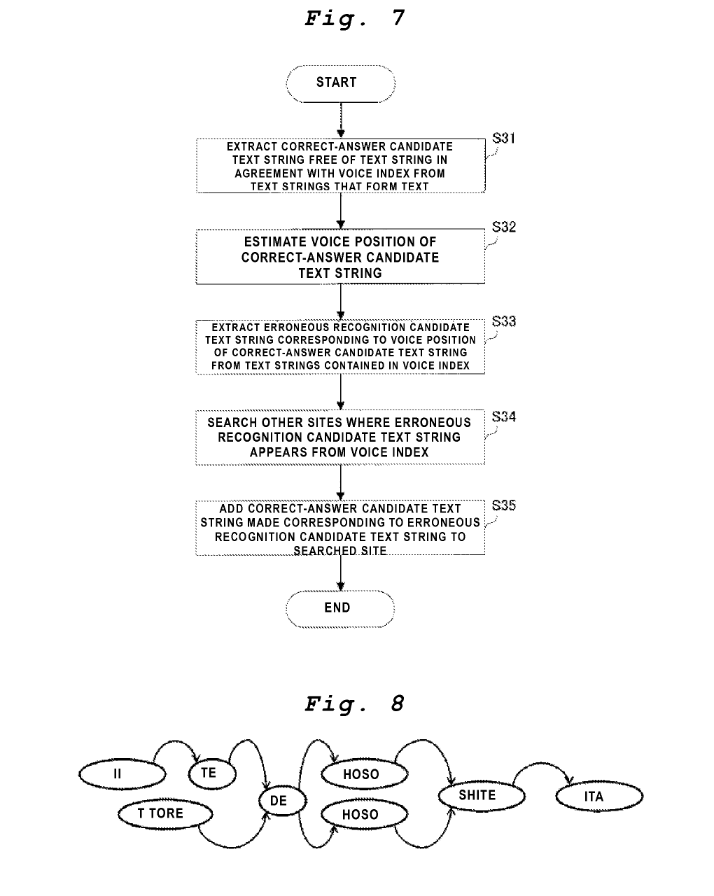

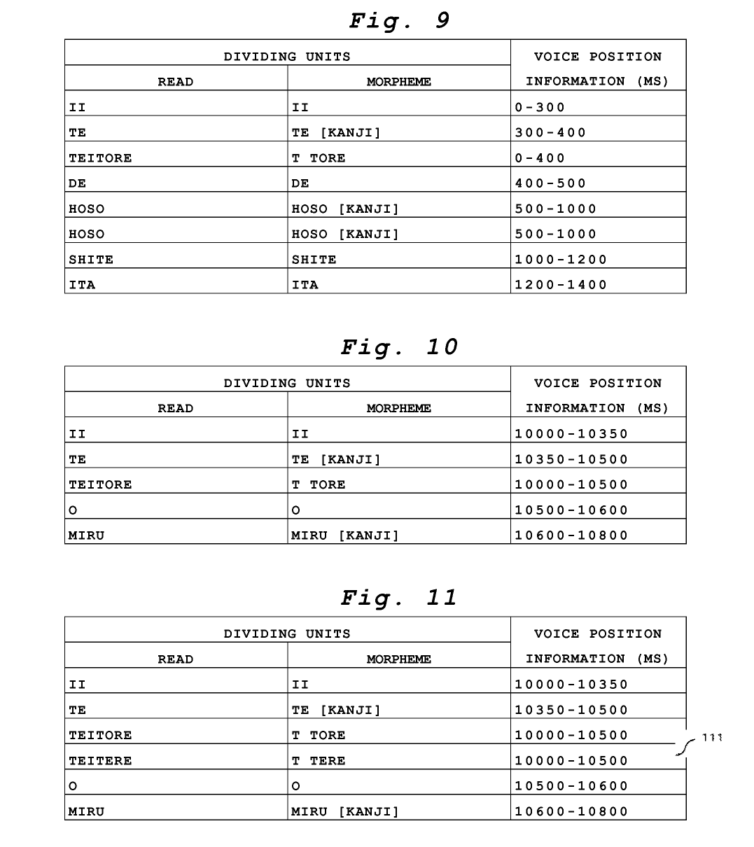

FIG. 7 is a flow chart illustrating an example of the processing carried out when the voice index is corrected by the transcription supporting system in the present example. As a specific example, it is assumed that the user (the transcription operator) listens to the voice data of “T tere de hoso shiteita” (In English: “broadcasting with T television”) while carrying out the transcription operation. In this example, before the start of the transcription operation, the voice text data shown in FIG. 8 are generated by the voice recognition module 13. Also, on the basis of the information acquired during the voice recognition processing in the voice recognition module 13, the index generating module 14 generates the voice index shown in FIG. 9. In this example, the recognition processing of the voice recognition module 13 erroneously recognizes the voice data of “T tere” as “ii”, “te” and “T tore”.

In the following, explanations will be made with reference to the flow chart shown in FIG. 7. First, the estimation module 18 extracts the correct-answer candidate text string free of text string in agreement with the voice index from the text strings that form the inputted text (step S31). That is, when a portion of the inputted text does not match the voice index, estimation module 18 extracts this portion from the inputted text as the correct-answer candidate text string. So, for example, if the user inputs the text string of “teitere” and confirms conversion of the input text string to Kanji. The inputted text of “T tere” is transmitted to the estimation module 18. In this case, there exists no text string in agreement with the “T tere” in the voice index shown in FIG. 9. Consequently, the estimation module 18 extracts the “T tere” as the correct-answer candidate text string. Judgment on whether there exists a text string in agreement with the inputted text can be made by matching the text strings that form the inputted text with the text strings of the phonemes of the voice index.

After extracting a correct-answer candidate text string, the estimation module 18 estimates the voice position information of the correct-answer candidate text string. In the present example, the estimation module 18 estimates the time needed for playing of “T tere.” The estimation module 18 converts the “T tere” to a phoneme string and, by using the data of the standard phoneme continuation time for each phoneme, estimates the time needed for playing (speaking) of “T tere.” As a result of the estimation process, the playing time of “T tere” is estimated to be 350 ms. In this case, it is estimated that the formed voice position information of the “T tere” is “0 ms-350 ms.”

In addition, as described in the first embodiment, the estimation module 18 uses the reference text string and the voice position information corresponding to the text string to estimate the voice position information of the correct-answer candidate text string. For example, when the inputted text transmitted to the estimation module 18 is “T tere de hoso”, the “hoso” at the end of the text string and “de” just preceding it are contained in the voice index. Consequently, it is possible to use the voice position information of these text strings to estimate the voice position information of the “T tere.” According to the voice index shown in FIG. 9, as the voice position information of “de hoso” is “400 ms-1000 ms,” the voice position information of the “T tere” can be estimated to be “0 ms-400 ms.”

After extraction and position estimation of the correct-answer candidate text string, the estimation module extracts the erroneous recognition text string corresponding to the voice position information of the correct-answer candidate text string from the text strings contained in the voice index (step S33). As shown in FIG. 9, the text string corresponding to the voice position information of “0 ms-350 ms” (the voice position of the correct-answer candidate text string “T tere”) is “ii te” and “T tore”. This extracted text string is called an erroneous recognition candidate text string.

The estimation module 18 has the correct-answer candidate text string (“T tere”) correspond to the erroneous recognition candidate text string (“ii te”, “T tore”). In this example, when just some portion of a text string contained in the voice index corresponds to the voice position information of the correct-answer candidate text string, this partially corresponding text string is also extracted as an erroneous recognition candidate text string. One could also adopt a scheme in which only when the entirety of the text string corresponds to the voice position information of the correct-answer candidate text string, is the text string is extracted as the erroneous recognition candidate text string. With that method, only “ii” would be extracted as an erroneous recognition candidate text string in this example.

Or following alternative scheme may be adopted: only when a similarity between the correct-answer candidate text string and the text string corresponding to the voice position information of the correct-answer candidate text string is over some prescribed value, will the estimation module 18 extracts the text string as an erroneous recognition candidate text string. By limiting extraction to text strings with similarity over a prescribed value, it is possible to prevent the text strings that should not be made to correspond to each other from being made to correspond to each other as a correct-answer candidate text string and an erroneous recognition candidate text string. The similarity comparison value may be computed by converting the text string to a phoneme string and using a predetermined distance table between phonemes and the like.

After the extraction of the erroneous recognition candidate text string, the index generating module 14 uses the correspondence relationship between the correct-answer candidate text string and the erroneous recognition candidate text string obtained in step S34 to search for other sites where the erroneous recognition candidate text strings appear in the voice index stored in the second storage module 15 (step S34). More specifically, the sites in the voice index where both “ii te” and “T tore” appear repeatedly are searched. The searching can be realized by matching the phonemes in the voice index to the text strings. In this example, the sites shown in FIG. 10 are searched. Here, the index generating module 14 may also search the sites where a portion of the erroneous recognition candidate text string (“ii te” or “T tore”) appears.

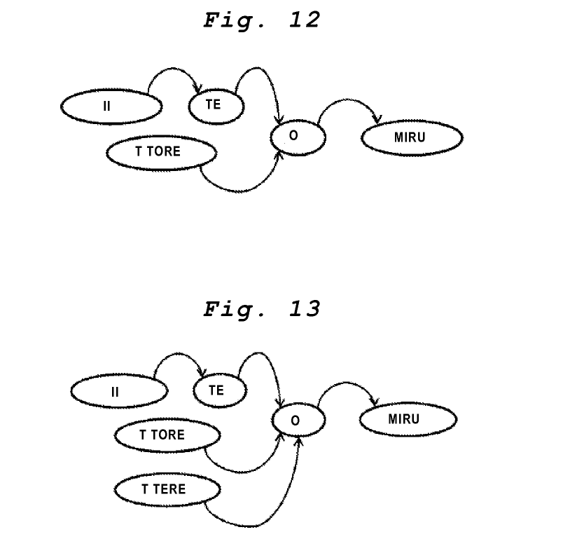

Then, the index generating module 14 adds the correct-answer candidate text string at the sites found in the search in step S34 (step S35). More specifically, as shown in 111 in FIG. 11, the phoneme of “T tere” and its pronunciation “teitere” are added to the voice position information corresponding to the searched “ii te” and “T tore.” This correction is represented in the lattice and corresponds to the change from FIG. 12 to FIG. 13. The index generating module 14 has the corrected voice index stored in the second storage module 15.

As explained above, in the transcription supporting system related to the present example, when a text string of the inputted text is not in agreement with the text strings contained in the voice index, the text string (the correct-answer candidate text string) is added to the voice index. As a result, it is possible to alleviate the influence of the erroneous recognition contained in the voice text, and, when the new voice data containing the correct-answer candidate text string are write-initiated, it is possible to increase the estimation precision of the formed voice position information.

For example, assume the user listens to the voice data of “T tere o miru” (in English: “watch T television”) while carrying out the transcription operation. In this case, after the correction/addition process described previously, instead of the voice index shown in FIG. 10, the voice index shown in FIG. 11 corrected by the index generating module 14 is used, so that it is possible to estimate the formed voice position information of the correct text string of “T tere” input by the user without carrying out another estimation of the playing time.

In this embodiment, the first storage module 11, playing module 12, and second storage module 15 are made of hardware circuits. On the other hand, the voice recognition module 13, index generating module 14, input receiving module 16, text forming module 17, estimation module 18, setting module 19, playing instruction receiving module 20, playing controller 21, and index generating module 14 are realized on CPU carried in a PC by executing a control program stored in the ROM (or the like). However, the present disclosure is not limited to that scheme. For example, at least a portion of the voice recognition module 13, index generating module 14, input receiving module 16, text forming module 17, estimation module 18, setting module 19, playing instruction receiving module 20, playing controller 21, and index generating module 14, may also be made of hardware circuits.

The following modified examples may be arbitrarily combined with one another and the described embodiments.

### (1) Modified Example 1

In the example embodiments described above, a PC is adopted as the transcription supporting system. However, the present disclosure is not limited to it. For example, one may also have a transcription supporting system including a first device (tape recorder or the like) with a function of playing the voice data and a second device with a text forming function. The various modules (first storage module 11, playing module 12, voice recognition module 13, index generating module 14, second storage module 15, input receiving module 16, text forming module 17, estimation module 18, setting module 19, playing instruction receiving module 20, playing controller 21, index generating module 14) may be contained in either or both of the first device and second device.

### (2) Modified Example 2

In the embodiments described above, the language taken as the subject of the transcription is Japanese. However, the present disclosure is not limited to this language. Any language or code may be adopted as the subject of the transcription. For example, English or Chinese may also be taken as the subject of the transcription.

When the user writes while listening to the English voice, the transcription text is in English. The method for estimating the formed voice position information in this case is similar to that of the Japanese voice. However, they are different in estimation of the first playing time and the second playing time. For the English, the input text strings are alphabetic (rather than logographic), so that a phoneme continuation time for alphabetic strings should be adopted. The first playing time and the second playing time may also be estimated using the phoneme continuation time of vowels and consonants and the continuation time in the phoneme units.

When a user listens to a Chinese voice while making a transcription, the transcription text is in Chinese. In this case, the method for estimating the formed voice position information is very similar to that of the Japanese voice. However, they are different from each other in estimating the first playing time and the second playing time. For Chinese language, the pinyin equivalent may be determined for each input character, and the phoneme continuation time for the pinyin string adopted for estimating the first playing time and the second playing time.

### (3) Modified Example 3

For the voice recognition module 13, one of the causes for the erroneous recognition of the voice data of “T tere” to “ii,” “te,” and “T tore” may be that the word of “T tere” is not registered in the recognition dictionary in the voice recognition module 13. Consequently, when the correct-answer candidate text string detected by the estimation module 18 is not registered in the recognition dictionary, the voice recognition module 13 in the transcription supporting system 200 may add the correct-answer candidate text string to the recognition dictionary. Then, by carrying out the voice recognition processing of the voice data by using the recognition dictionary after adding the registration, it is possible to decrease the number of erroneous recognitions contained in the voice text.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transcription supporting system, comprising:
a first storage module configured to store voice data;
a playing module configured to play the voice data;
a voice recognition module configured to execute voice recognition processing on the voice data;
an index generating module configured to generate a voice index, the voice index including a plurality of text strings generated by the voice recognition processing and voice position data, the voice position data indicating a position of each of the plurality of text strings in the voice data;
a second storage module configured to store the voice index;
a text forming module configured to correct one of the text strings generated by the voice recognition processing according to a text input by a user; and
an estimation module configured to estimate a position in the voice data where the correction was made based on the voice index.

2. The transcription supporting system according to claim 1, wherein
the estimation module is configured to extract a correct-answer candidate text string from the inputted text when the inputted text does not match the plurality of text strings in the voice index and to extract an erroneous-recognition candidate text string corresponding to the voice position data of the correct-answer candidate text string from the plurality of text strings in the voice index, and
the index generating module is configured to associate the correct-answer candidate text string with the voice position data of the erroneous-recognition candidate text string and add the correct-answer candidate text string to the voice index.

3. The transcription supporting system according to claim 2, wherein the estimation module uses a time needed for playing of the correct-answer candidate text string to estimate the position in the voice data where the correction was made.

4. The transcription supporting system according to claim 2, wherein
when a similarity value resulting from a comparison between the correct-answer candidate text string and the text string corresponding to the voice position data of the correct-answer candidate text string is over a prescribed level, the text string corresponding to the voice position data of the correct-answer candidate string is extracted as the erroneous-recognition candidate text string.

5. The transcription supporting system according to claim 4, wherein the similarity is computed by a comparison of similarities of phoneme strings that form the text strings.

6. The transcription supporting system according to claim 1, wherein
the estimation module is configured to extract the correct-answer candidate text string from the inputted text when there is no text string in the inputted text that matches the plurality of text strings in the voice index, and
the correct-answer candidate text string is added to a recognition dictionary, the recognition dictionary for use in voice recognition processing.

7. The transcription supporting system according to claim 2, wherein
the index generating module is configured to replace the erroneous recognition text string in the voice index with the correct-answer candidate text string when the erroneous recognition text string is located at a plurality of other sites in the voice index.

8. The transcription supporting system according to claim 1, wherein
the first storage module and the second storage module are implemented in a single storage device.

9. The transcription supporting system according to claim 1, further comprising:
an input receiving module configured to receive the input operation from the user and to provide the input operation to the text forming module.

10. The transcription supporting system according to claim 1, further comprising:
a setting module configured to set a starting position for a playing of the voice data, the starting position corresponding to the position in the voice data estimated by the estimation part;
a playing instruction receiving module configured to receive an instruction for initiating the playing of the voice data; and
a playing controller configured to control the playing module such that the playing of the voice data begins from the starting position set by the setting module when the playing instruction receiving module receives the instruction for initiating the playing of the voice data.

11. The transcription supporting system according to claim 1, wherein the voice data comprises Japanese, Chinese, or English speech.

12. The transcription supporting system according to claim 1, wherein
when the inputted text does not match the plurality of text strings in the voice index, the inputted text is added to the voice index to correct the voice index.

13. A transcription supporting system, comprising:
a playing module configured to play voice data;
a voice recognition module configured to execute a voice recognition processing on the voice data;
an index generating module configured to generate a voice index, the voice index including a plurality of text strings generated by the voice recognition processing and voice position data, the voice position data indicating a position of each of the plurality of text strings in the voice data;
a text forming module configured to correct one of the text strings generated by the voice recognition processing, the correction according to an inputted text corresponding to an input operation of a user; and
an estimation module configured to estimate a position in the voice data where the correction was made based on the voice index;
wherein the estimation module is configured to extract a correct-answer candidate text string from the inputted text when the inputted text does not match the plurality of text strings in the voice index and to extract an erroneous-recognition candidate text string corresponding to the voice position data of the correct-answer candidate text string from the plurality of text strings in the voice index, and
the index generating module is configured to associate the correct-answer candidate text string with the voice position data of the erroneous-recognition candidate text string and add the correct-answer candidate text string to the voice index.

14. The transcription supporting system according to claim 13, further comprising:
a setting module configured to set a starting position for a playing of the voice data, the starting position corresponding to the position in the voice data where the correction was made;
a playing instruction receiving module configured to receive an instruction for initiating the playing of the voice data; and
a playing controller configured to control the playing module such that the playing of the voice data begins from the starting position set by the setting module when the playing instruction receiving module receives the instruction for initiating the playing of the voice data.

15. The transcription supporting system according to claim 14, further comprising:
an input receiving module configured to receive the input operation from the user and to provide the input operation to the text forming module.

16. The transcription supporting system according to claim 15, further comprising:
a first storage module configured to store the voice data;
a second storage module configured to store the voice index.

17. A transcription supporting method, comprising:
obtaining voice data;
performing a voice recognition processing on the voice data, the voice recognition processing generating a plurality of text strings from the voice data;
generating a voice index, the voice index including the plurality of text strings generated by the voice recognition process, each text string of the plurality of text strings in correspondence with voice position data, the voice position data indicating a position for each of the plurality of text strings in the voice data;
correcting one of the text strings generated by the voice recognition processing according to a text input by a user; and
estimating a position in the voice data corresponding to the a position of the correction based on the voice index.

18. The transcription supporting method of claim 17, further comprising:
storing the voice data in a first storage module; and
storing the voice index in a second storage module.

19. The transcription supporting method of claim 17, further comprising:
extracting a correct-answer candidate text string when there is no text string in the text input by the user that matches the plurality of text strings in the voice index;
extracting an erroneous-recognition candidate text string corresponding to the voice position data of the correct-answer candidate text string from the plurality of text strings in the voice index; and
associating the correct-answer candidate text string with the voice position data of the erroneous-recognition candidate text string and adding the correct-answer candidate text string to the voice index.

20. The transcription supporting method of claim 19, further comprising:
adding the correct-answer candidate text string to a recognition dictionary when the text input by the user does not match the plurality of text strings in the voice index; and
correcting the voice index by determining other instances of erroneous recognition in the plurality of text strings contained in the voice index and replacing the erroneous-recognition candidate text string with the correct-answer candidate text string.
